(19) United States
(12) Patent Application Publication
(10) Pub. No.: US 2010/0065037 A1
(43) Pub. Date: Mar. 18, 2010

(54) Accelerated Cure Cycle Process

(75) Inventor: Robert W. Root, Newark, DE (US)

Correspondence Address: TUNG & ASSOCIATES / RANDY W. TUNG, ESQ., 838 W. LONG LAKE ROAD, SUITE 120, BLOOMFIELD HILLS, MI, 48302, US

(73) Assignee: The Boeing Company

(21) Appl. No.: 12/211,021

(22) Filed: Sep. 15, 2008

(51) Int. Cl. F24J 1/00; C09K 5/18

(52) U.S. Cl. 126/263.02

(57) ABSTRACT

An accelerated cure cycle process includes providing a substrate having an area to be heated and cured, providing an exothermic chemical reaction warmer in thermal contact with the area and curing the area by initiating and sustaining an exothermic chemical reaction in the exothermic chemical reaction warmer.

### TECHNICAL FIELD OF THE INVENTION

The disclosure relates to heating of materials to accelerate the cure cycle of the materials. More particularly, the disclosure relates to an accelerated cure cycle process in which an exothermic chemical reaction warmer is placed in thermal contact with a material to heat and accelerate curing of the material.

### BACKGROUND OF THE INVENTION

Fabrication and repair or maintenance of aircraft and other vehicles and equipment may require the use of curable materials such as adhesives and coatings, for example and without limitation. These materials may require curing or hardening before additional fabrication, repair or maintenance work can be performed or before the equipment can be used. Care not to disturb the materials during the cure cycle time period may be required to avoid jeopardizing quality in bonding strength or surface finish. Therefore, during the cure cycle time period it may be required that the equipment sit idle and essentially off the manufacturing line or out of service.

Coatings and other materials may be cured at room temperature, which may be a slow process. To accelerate a cure cycle, heat may be applied to the material using ovens, heat blankets or heat lamps. However, these heating devices may be complicated and time-consuming to set up and operate. Furthermore, the heating devices may require a supply of electrical power from an exterior source as well as temperature controlling or monitoring by personnel to prevent over (or under) heating of the material.

Methods which require temperature controllers and/or monitoring may require special training and sometimes, different job classifications from that of the person who performs the initial work. Additionally, these methods may prove to be cumbersome, complicated and expensive to utilize. Thus, slower cure cycles which utilize ambient heating may be utilized instead to implement the curing process.

Accordingly, an accelerated cure cycle process in which an exothermic chemical reaction warmer is placed in thermal contact with a material to heat and accelerate curing of the material may be useful in some applications.

### SUMMARY OF THE INVENTION

The disclosure is generally directed to an accelerated cure cycle process. An illustrative embodiment of the process includes providing a substrate having an area to be heated and cured, providing an exothermic chemical reaction warmer in thermal contact with the area and curing the area by initiating and sustaining an exothermic chemical reaction in the exothermic chemical reaction warmer.

### BRIEF DESCRIPTION OF THE ILLUSTRATIONS

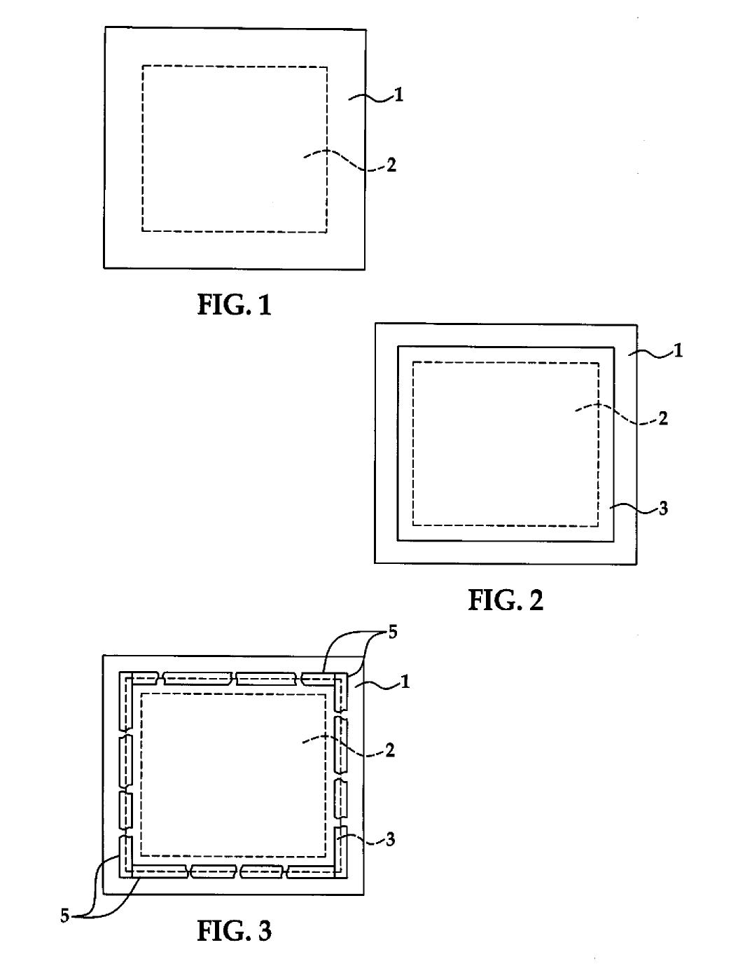

FIGS. 1-5 are top views, respectively, of a substrate and an area on the substrate which is to be heated, more particularly illustrating heating of the area according to an illustrative embodiment of the accelerated cure cycle process.

FIG. 6 is a flow diagram of an illustrative embodiment of an accelerated cure cycle process.

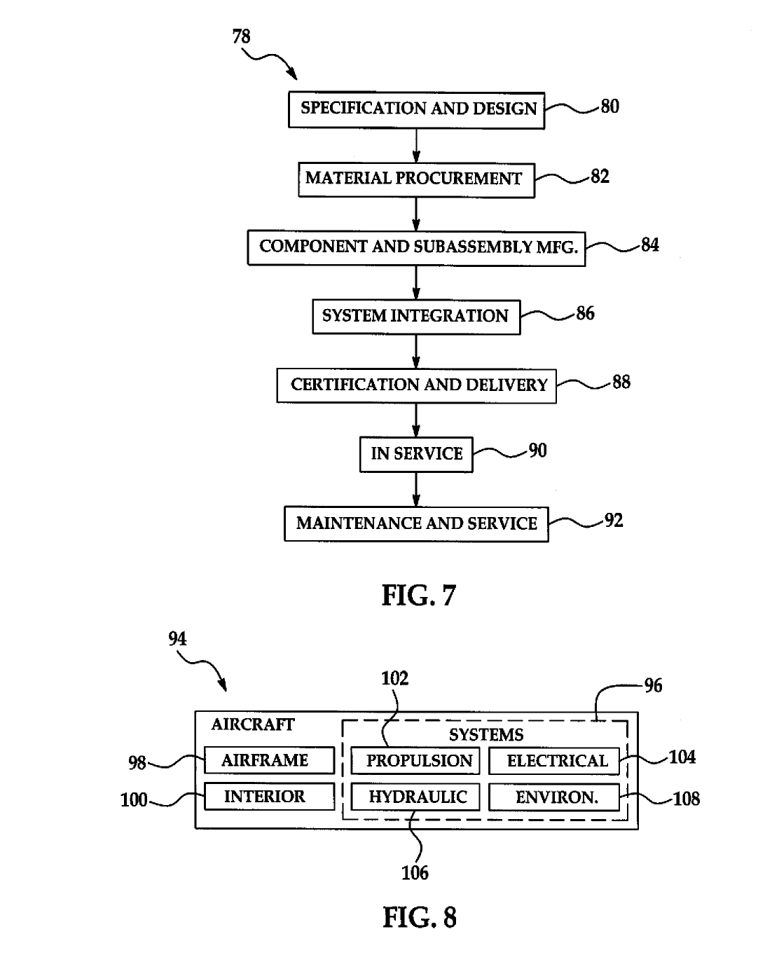

FIG. 7 is a flow diagram of an aircraft production and service methodology.

FIG. 8 is a block diagram of an aircraft.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the invention and are not intended to limit the scope of the invention which is defined by the claims. Furthermore, there is no intention to be bound by any expressed or implied theory presented in the preceding technical field, background, brief summary or the following detailed description.

The disclosure is generally directed to an accelerated cure cycle process in which an exothermic chemical reaction warmer is placed in thermal contact with a material to heat and accelerate curing of the material. The exothermic chemical reaction warmer may utilize a simple, repeatable, inexpensive and easy-to-use internal source of heat to generate thermal energy which is imparted to the material to be cured without requiring an external energy source or controller for the purpose. Furthermore, the process may utilize exothermic chemical reaction warmers which are inexpensive and readably available commercially.

Referring initially to FIGS. 1-6, heating of an area 2 according to an illustrative embodiment of the accelerated cure cycle process is shown. The area 2 may be heated in order to accelerate curing of the area 2, for example and without limitation. As shown in FIG. 1, in some applications the area to be heated 2 may be provided on a substrate 1. The area to be heated 2 may be an adhesive, a sealant or a surface finish or paint, for example and without limitation, which may be applied to the substrate 1. In some applications, the area to be heated 2 may be a bonding surface or adhesive for bonding a clickstud (not shown) to the substrate 1, for example and without limitation. In some applications, the area to be heated 2 may be a 2-part epoxy adhesive such as Hysol EA956; Hysol EA9930; Hysol EA9377; Hysol 9394; or Hysol EA9396, for example and without limitation. For example, the area to be heated 2 may be a polyamine-based 2-part epoxy such as Hysol EA9377 or a polyether-based 2-part epoxy such as PR 1826, for example and without limitation. In some applications, the area to be heated 2 may be a paint such as a polyamide-based 2-part epoxy paint such as MIL-PRF-22750 or MIL-PRF-22750F, for example and without limitation.

As shown in FIG. 2, an exothermic chemical reaction warmer 3 may be loosely placed over the area to be heated 2. The exothermic chemical reaction warmer 3 may be any type of packaged warming device which contains chemicals that react and dissipate heat in an exothermic chemical reaction. The exothermic chemical reaction warmer 3 may be a commercially-available hand warmer, for example and without limitation. Such exothermic chemical reaction warmers 2 may be inexpensive, easy to use and repeatable in the quantity of heat generated, and may be disposable. Upon its removal from the package (not shown) in which it is stored, the chemicals in the exothermic chemical reaction warmer 3 may be exposed to oxygen, initiating and sustaining an exothermic chemical reaction which generates heat. As shown in FIG. 3, strips of tape 5 may be used to secure the exothermic chemical reaction warmer 3 in place and may be applied around the edges of the exothermic chemical reaction warmer 3, as shown. Other methods and techniques which are known to those skilled in the art may be used to secure the exothermic chemical reaction warmer 3 in place. The edges of the exothermic chemical reaction warmer 3 should not be sealed with the tape 5 or other sealant since oxygen must continuously contact the exothermic chemical reaction warmer 3 for effective heating. Accordingly, the exothermic chemical reaction warmer 3 may impart thermal energy to the area to be heated 2 by conduction and/or convection. The imparted heat may accelerate curing of the area to be heated 2.

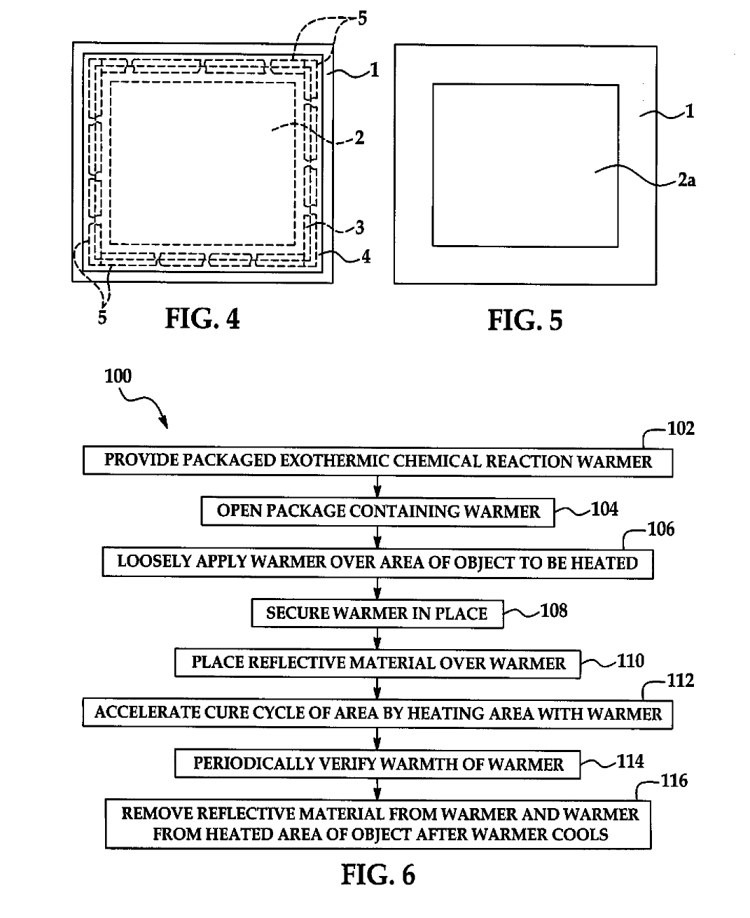

As shown in FIG. 4, reflective material 4 may be placed over the secured exothermic chemical reaction warmer 3. The reflective material 4 may be aluminum foil, for example and without limitation. The reflective material 4 may reflect heat into and reduce large quantities of air movement around the area to be heated 2.

The exothermic chemical reaction warmer 3 may remain in place on the area to be heated 2 until heat is no longer generated. Accordingly, the exothermic chemical reaction warmer 3 may be periodically checked to determine whether it is warm. In some applications, the exothermic chemical reaction warmer 3 may generate an average heat of about 135 degrees F for at least about 7 hours. At this temperature, the area to be heated 2 may be fully cured in only 4 hours. After cooling of the exothermic chemical reaction warmer 3, the reflective material 4 may be removed from the area to be heated 2; the tape 5 may be removed from the edges of the exothermic chemical reaction warmer 3; and the exothermic chemical reaction warmer 3 may be removed from the area to be heated 2, exposing the cured area 2a, as shown FIG. 5.

Referring next to FIG. 6, a flow diagram 100 of an illustrative embodiment of an accelerated cure cycle process is shown. In block 102, a packaged exothermic chemical reaction warmer is provided. In block 104, a package which contains the warmer is opened. This may expose the chemicals in the warmer to oxygen which initiates and sustains an exothermic chemical reaction and causes the warmer to emit heat. In block 106, the warmer is loosely placed over an area which is to be heated and cured on an object. In block 108, the warmer may be secured in place such as by using tape, for example and without limitation. In block 110, a reflective material may be placed over the warmer. In block 112, the cure cycle of the area on the object is accelerated by self-heating of the warmer. In block 114, the warmth of the warmer may be periodically checked or verified. In block 116, after the warmer cools, the reflective material is removed from the warmer and the warmer is removed from the heated and cured area.

Referring next to FIGS. 7 and 8, embodiments of the disclosure may be used in the context of an aircraft manufacturing and service method 78 as shown in FIG. 7 and an aircraft 94 as shown in FIG. 8. During pre-production, exemplary method 78 may include specification and design 80 of the aircraft 94 and material procurement 82. During production, component and subassembly manufacturing 84 and system integration 86 of the aircraft 94 takes place. Thereafter, the aircraft 94 may go through certification and delivery 88 in order to be placed in service 90. While in service by a customer, the aircraft 94 may be scheduled for routine maintenance and service 92 (which may also include modification, reconfiguration, refurbishment, and so on).

Each of the processes of method 78 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. B, the aircraft 94 produced by exemplary method 78 may include an airframe 98 with a plurality of systems 96 and an interior 100. Examples of high-level systems 96 include one or more of a propulsion system 102, an electrical system 104, a hydraulic system 106, and an environmental system 108. Any number of other systems may be included. Although an aerospace example is shown, the principles of the invention may be applied to other industries, such as the automotive industry.

The apparatus embodied herein may be employed during any one or more of the stages of the production and service method 78. For example, components or subassemblies corresponding to production process 84 may be fabricated or manufactured in a manner similar to components or subassemblies produced while the aircraft 94 is in service. Also, one or more apparatus embodiments may be utilized during the production stages 84 and 86, for example, by substantially expediting assembly of or reducing the cost of an aircraft 94. Similarly, one or more apparatus embodiments may be utilized while the aircraft 94 is in service, for example and without limitation, to maintenance and service 92.

Although the embodiments of this disclosure have been described with respect to certain exemplary embodiments, it is to be understood that the specific embodiments are for purposes of illustration and not limitation, as other variations will occur to those of skill in the art.

What is claimed is:

1. An accelerated cure cycle process, comprising:
providing a substrate having an area to be heated and cured;
providing an exothermic chemical reaction warmer in thermal contact with said area; and
curing said area by initiating and sustaining an exothermic chemical reaction in said exothermic chemical reaction warmer.

2. The process of claim 1 wherein said initiating and sustaining an exothermic chemical reaction in said exothermic chemical reaction warmer comprises exposing said exothermic chemical reaction warmer to oxygen.

3. The process of claim 2 wherein said exposing said exothermic chemical reaction warmer to oxygen comprises providing a package and removing said exothermic chemical reaction warmer from said package.

4. The process of claim 1 further comprising securing said exothermic chemical reaction warmer in thermal contact with said area.

5. The process of claim 4 wherein said securing said exothermic chemical reaction warmer in thermal contact with said area comprises taping said exothermic chemical reaction warmer to said substrate.

6. The process of claim 1 wherein said area comprises an adhesive.

7. The process of claim 1 wherein said area comprises a sealant.

8. The process of claim 1 wherein said area comprises a surface finish.

9. The process of claim 1 wherein said providing a substrate having an area to be heated comprises providing a substrate having a 2-part epoxy adhesive.

10. The process of claim 1 wherein said providing a substrate having an area to be heated comprises providing a substrate having a polyamide-based 2-part epoxy paint.

11. An accelerated cure cycle process, comprising:
providing a substrate having an area to be heated and cured;
providing an exothermic chemical reaction warmer in thermal contact with said area;
providing a reflective material;
placing said reflective material over said exothermic chemical reaction warmer; and
curing said area by initiating and sustaining an exothermic chemical reaction in said exothermic chemical reaction warmer.

12. The process of claim 11 wherein said initiating and sustaining an exothermic chemical reaction in said exothermic chemical reaction warmer comprises exposing said exothermic chemical reaction warmer to oxygen.

13. The process of claim 12 wherein said exposing said exothermic chemical reaction warmer to oxygen comprises providing a package and removing said exothermic chemical reaction warmer from said package.

14. The process of claim 11 further comprising securing said exothermic chemical reaction warmer in thermal contact with said area.

15. The process of claim 14 wherein said securing said exothermic chemical reaction warmer in thermal contact with said area comprises taping said exothermic chemical reaction warmer to said substrate.

16. The process of claim 11 wherein said area comprises an adhesive.

17. The process of claim 11 wherein said area comprises a sealant.

18. The process of claim 11 wherein said area comprises a surface finish.

19. An accelerated cure cycle process, comprising:
providing a substrate having an area to be heated and cured;
providing an exothermic chemical reaction warmer sealed in a package;
removing said exothermic chemical reaction warmer from said package;
placing said exothermic chemical reaction warmer in thermal contact with said area;
providing a reflective material;
placing said reflective material over said exothermic chemical reaction warmer; and
curing said area by initiating and sustaining an exothermic chemical reaction in said exothermic chemical reaction warmer.

20. The process of claim 19 wherein said area comprises an adhesive.

21. The process of claim 19 wherein said area comprises a sealant.

22. The process of claim 19 wherein said area comprises a surface finish.

23. An accelerated cure cycle process, comprising:
providing a substrate having an area to be heated and cured;
providing an exothermic chemical reaction warmer sealed in a package;
opening said package;
removing said exothermic chemical reaction warmer from said package;
placing and securing said exothermic chemical reaction warmer in thermal contact with said area;
providing a reflective material;
placing said reflective material over said exothermic chemical reaction warmer;
curing said area by initiating and sustaining an exothermic chemical reaction in said exothermic chemical reaction warmer;
periodically verifying warmth of said exothermic chemical reaction warmer; and
removing said exothermic chemical reaction warmer from said area after said exothermic chemical reaction warmer cools.
